(19) United States
(12) Patent Application Publication
(10) Pub. No.: US 2012/0166508 A1
(43) Pub. Date: Jun. 28, 2012

(54) FAST FOURIER TRANSFORMER

(75) Inventors: Jin Kyu Kim, Daejeon (KR); Young Seok Baek, Daejeon (KR); Byung Jo Kim, Daejeon (KR); Bon Tae Koo, Daejeon (KR)

(73) Assignee: Electronics and Telecommunications Research Institute, Daejeon (KR)

(21) Appl. No.: 13/305,450

(22) Filed: Nov. 28, 2011

(30) Foreign Application Priority Data
Dec. 23, 2010 (KR) 10-2010-0134061

(51) Int. Cl. G06F 17/14

(52) U.S. Cl. 708/404

(57) ABSTRACT

A fast Fourier transformer (FFT) includes a radix-2 butterfly unit configured to perform a butterfly operation on input data; a buffer unit configured to buffer data outputted from the radix-2 butterfly unit and output the buffered data to the radix-2 butterfly unit; a multiplexing unit configured to selectively output a twiddle factor; and a constant multiplier configured to multiply the data outputted from the radix-2 butterfly unit by the twiddle factor outputted from the multiplexing unit.

### CROSS-REFERENCES TO RELATED APPLICATIONS

The present application claims priority under 35 U.S.C. 119(a) to Korean Application No. 10-2010-0134061, filed on Dec. 23, 2010 in the Korean intellectual property Office, which is incorporated herein by reference in its entirety set forth in full.

### BACKGROUND

Exemplary embodiments of the present invention relate to a fast Fourier transformer (FFT), and more particularly, to an FFT which is widely used in a signal processing field such as an orthogonal frequency division multiplexing (OFDM) modulation and demodulation communication system.

An FFT is widely used in a signal processing field such as an OFDM modulation and demodulation communication system.

Such an FFT is a component which is essentially used in an OFDM receiver. As the length of the FFT increases, the calculation thereof becomes very complicated. Accordingly, a variety of design methods for overcoming such a problem have been proposed.

In general, a method of designing an FFT is divided into an in-place method and a pipelined method.

In the in-place method, a single memory having an address size corresponding to the length of the FFT is provided, and data is read at a specific address, subjected to a radix-r operation, and then stored in a memory space having the same address.

In the in-place method, since a single radix-r unit is used, the entire operation time increases with the length of the FFT and the number of stages. However, since the single radix-r unit is used, the in-place method has an advantage in terms of the circuit size.

In the pipelined method, the architecture of the FFT includes a plurality of stages which are coupled in series to each other. Each of the stages has its own radix-r unit and separately includes a buffer for storing data.

Therefore, since the respective stages operate independently, a plurality of radix-r operations may be performed at the same time. Therefore, while the memory is used at the same level as the in-place design method, the pipeline design method exhibits much higher throughput than in the in-place design method, because the respective stages may perform radix-r operations at the same time.

The above-described technical configuration is a related art for helping an understanding of the present invention, and does not indicate a prior art which is widely known in the technical field to which the present invention pertains.

### SUMMARY

An embodiment of the present invention relates to an FFT which minimizes the number of complex multipliers used for designing an FFT in a pipelined method and optimizes the number of multipliers, thereby reducing a circuit size and power consumption.

In one embodiment, an FFT includes a radix-2 butterfly unit configured to perform a butterfly operation on input data; a buffer unit configured to buffer data outputted from the radix-2 butterfly unit and output the buffered data to the radix-2 butterfly unit; a multiplexing unit configured to selectively output a twiddle factor; and a constant multiplier configured to multiply the data outputted from the radix-2 butterfly unit by the twiddle factor outputted from the multiplexing unit.

The FFT may further include a radix-2⁵ butterfly processor in which the radix-2 butterfly unit, the buffer unit, the multiplexing unit, and the constant multiplier are configured as one stage.

The FFT may further include a radix-2^{m} butterfly processor in which the radix-2 butterfly unit, the buffer unit, the multiplexing unit, and the constant multiplier are configured as one stage.

The twiddle factor may be induced according to a division method based on a common factor algorithm in a discrete Fourier transform (DFT) formula.

The buffer unit may perform buffering as much as the butterfly operation time of the radix-2.

In another embodiment, an FFT includes a radix-2⁵ butterfly processor configured to perform a butterfly operation on input data; a memory unit configured to store data outputted from the radix-2⁵ butterfly processor and output the buffered data to the radix-2⁵ butterfly processor; a twiddle ROM configured to store a twiddle factor; and a multiplier configured to multiply the data outputted from the radix-2⁵ butterfly processor by the twiddle factor outputted from the twiddle ROM.

The radix-2⁵ butterfly processor, the memory unit, the twiddle ROM, and the multiplier may be connected in a pipelined method.

The twiddle factor may be induced according to a division method based on a common factor algorithm in a DFT formula.

### BRIEF DESCRIPTION OF THE DRAWINGS

The above and other aspects, features and other advantages will be more clearly understood from the following detailed description taken in conjunction with the accompanying drawings, in which:

FIG. 1 is a diagram explaining the configuration of an FFT using radix-2⁵ in accordance with an embodiment of the present invention

FIG. 2 is a diagram explaining a data flow of the FFT using radix-2⁵ in accordance with the embodiment of the present invention; and

FIG. 3 is a diagram explaining the configuration of a 32K-point FFT in accordance with an embodiment of the present invention.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

The drawings are not necessarily to scale and in some instances, proportions may have been exaggerated in order to clearly illustrate features of the embodiments. Furthermore, terms to be described below have been defined by considering functions in embodiments of the present invention, and may be defined differently depending on a user or operator's intention or practice. Therefore, the definitions of such terms will be based on the descriptions of the entire present specification.

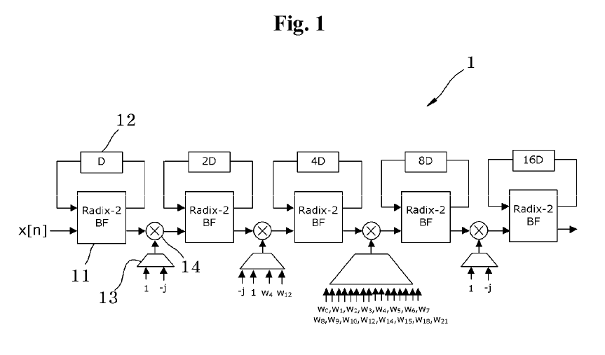

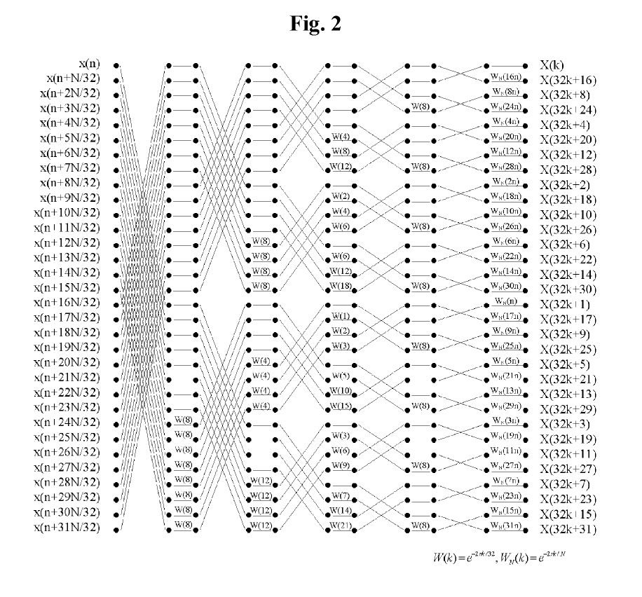

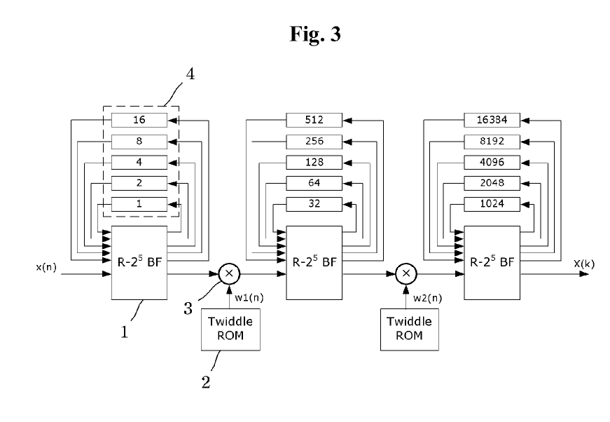

FIG. 1 is a diagram explaining the configuration of an FFT using radix-2⁵ in accordance with an embodiment of the present invention. FIG. 2 is a diagram explaining a data flow of the FFT using radix-2⁵ in accordance with the embodiment of the present invention. FIG. 3 is a diagram explaining the configuration of a 32K-point FFT in accordance with an embodiment of the present invention.

Referring to FIGS. 1 and 2, the FFT using radix-2⁵ in accordance with the embodiment of the present invention includes a radix-2 butterfly unit 11, a buffer unit 12, a multiplexing unit 13, and a constant multiplier 14.

The radix-2 butterfly unit 11 is configured to perform a butterfly operation on input data x[n].

The buffer unit 12 is configured to buffer data outputted from the radix-2 butterfly unit 11 and output the buffered data to the radix-2 butterfly unit 11.

The multiplexing unit 13 is configured to selectively output a twiddle factor.

The constant multiplier 14 is configured to multiply the data outputted from the radix-2 butterfly unit 11 by the twiddle factor outputted from the multiplexing unit 13.

The radix-2 butterfly unit 11, the buffer unit 12, the multiplexing unit 13, and the constant multiplier 14 form a radix-2⁵ butterfly processor as one stage.

Here, the twiddle factor is induced by a division method based on a common factor algorithm in a discrete Fourier transform (DFT) formula.

A formula derivation process for designing the radix-2⁵ butterfly processor will be described as follows.

Equation 1 is a general DFT formula.

$$X ( k ) = {\sum }_{n = 0}^{N - 1} x ( n ) {W}_{N}^{nk} , k = 0 , … , N - 1 \\ where {W}_{N}^{nk} = {e}^{\frac{- j2π nk}{N}} \qquad [ Equation 1 ]$$

In order to divide this by radix-2⁵, a division method as expressed by Equation 2 below is used. In the division method, a variable n is divided into n₁ to n₆, and a variable k is divided into k₁ to k₆ according to a common factor algorithm.

$$n = \frac{N}{2} {n}_{1} + \frac{N}{4} {n}_{2} + \frac{N}{8} {n}_{3} + \frac{N}{16} {n}_{4} + \frac{N}{32} {n}_{5} + {n}_{6} \\ where {n}_{1} = \{ 0 , 1 \} , {n}_{2} = \{ 0 , 1 \} , {n}_{3} = \{ 0 , 1 \} , {n}_{4} = \{ 0 , 1 \} , \\ {n}_{5} = \{ 0 , 1 \} , {n}_{6} = \{ 0 , 1 , … , \frac{N}{32} - 1 \} \\ k = {k}_{1} + 2 {k}_{2} + 4 {k}_{3} + 8 {k}_{4} + 16 {k}_{5} + 32 {k}_{6} \\ where {k}_{1} = \{ 0 , 1 \} , {k}_{2} = \{ 0 , 1 \} , {k}_{3} = \{ 0 , 1 \} , {k}_{4} = \{ 0 , 1 \} , \\ {k}_{5} = \{ 0 , 1 \} , {k}_{6} = \{ 0 , 1 , … , \frac{N}{32} - 1 \} \qquad [ Equation 2 ]$$

Equation 2 may be applied to Equation 1 to derive Equation 3 as expressed below.

$$X ( {k}_{1} + 2 {k}_{2} + 4 {k}_{3} + 8 {k}_{4} + 16 {k}_{5} + 32 {k}_{6} ) = {\sum }_{{n}_{6} = 0}^{N / 32 - 1} {\sum }_{{n}_{5} = 0}^{1} {\sum }_{{n}_{4} = 0}^{1} {{\sum }_{{n}_{3} = 0}}^{1} {\sum }_{{n}_{2} = 0}^{1} {\sum }_{{n}_{1} = 0}^{1} \\ [ x ( \begin{matrix}\begin{matrix}\frac{N}{2} {n}_{1} + \frac{N}{4} {n}_{2} + \\ \frac{N}{8} {n}_{3} + \frac{N}{16} {n}_{4} +\end{matrix} \\ \frac{N}{32} {n}_{5} + {n}_{6}\end{matrix} ) ] \cdot {W}_{N}^{( \frac{N}{2} {n}_{1} + \frac{N}{4} {n}_{2} + \frac{N}{8} {n}_{3} + \frac{N}{16} {n}_{4} + \frac{n}{32} {n}_{5} + {n}_{6} ) ( {k}_{1} + 2 {k}_{2} + 4 {k}_{3} + 8 {k}_{4} + 16 {k}_{5} + 32 {k}_{6} )} = {\sum }_{{n}_{6} = 0}^{N / 32 - 1} {\sum }_{{n}_{5} = 0}^{1} {\sum }_{{n}_{4} = 0}^{1} {\sum }_{{n}_{3} = 0}^{1} {\sum }_{{n}_{2} = 0}^{1} {\sum }_{{n}_{1} = 0}^{1} [ x ( \begin{matrix}\begin{matrix}\frac{N}{2} {n}_{1} + \frac{N}{4} {n}_{2} + \\ \frac{N}{8} {n}_{3} + \frac{n}{16} {n}_{4} +\end{matrix} \\ \frac{N}{32} {n}_{5} + {n}_{6}\end{matrix} ) ] \cdot {W}_{2}^{{n}_{1} {k}_{1}} {W}_{4}^{{n}_{2} ( {k}_{1} + 2 {k}_{2} )} {W}_{8}^{{n}_{3} ( {k}_{1} + 2 {k}_{2} + 4 {k}_{3} )} {W}_{16}^{{n}_{4} ( {k}_{1} + 2 {k}_{2} + 4 {k}_{3} + 8 {k}_{4} )} {W}_{32}^{{n}_{5} ( {k}_{1} + 2 {k}_{2} + 4 {k}_{3} + 8 {k}_{4} + 16 {k}_{5} )} {W}_{N}^{{n}_{6} ( {k}_{1} + 2 {k}_{2} + 4 {k}_{3} + 8 {k}_{4} + 16 {k}_{5} )} {W}_{N / 32}^{{n}_{6} {k}_{6}} = {\sum }_{{n}_{6} = 0}^{N / 32 - 1} {\sum }_{{n}_{5} = 0}^{1} {\sum }_{{n}_{4} = 0}^{1} {\sum }_{{n}_{3} = 0}^{1} {\sum }_{{n}_{2} = 0}^{1} {\sum }_{{n}_{1} = 0}^{1} x ( \begin{matrix}\frac{N}{2} {n}_{1} + \frac{N}{2} {n}_{2} + \frac{N}{8} {n}_{3} + \\ \frac{N}{16} {n}_{4} + \frac{N}{32} {n}_{5} + {n}_{6}\end{matrix} ) = {\sum }_{{n}_{6} = 0}^{N / 32 - 1} [ \{ {\sum }_{{n}_{5} = 0}^{1} \begin{matrix}\{ {\sum }_{{n}_{4} = 0}^{1} \begin{matrix}\{ {\sum }_{{n}_{3} = 0}^{1} \begin{matrix}\{ \begin{matrix}{\sum }_{{n}_{2} = 0}^{1} \{ {\sum }_{{n}_{1} = 0}^{1} x ( \begin{matrix}\begin{matrix}\frac{N}{2} {n}_{1} + \frac{N}{4} {n}_{2} + \\ \frac{N}{8} {n}_{3} + \frac{N}{16} {n}_{4} +\end{matrix} \\ \frac{N}{32} {n}_{5} + {n}_{6}\end{matrix} \} {W}_{2}^{{n}_{1} {k}_{1}} \} \cdot \\ {W}_{4}^{{n}_{2} {k}_{1}} {W}_{2}^{{n}_{2} {k}_{2}}\end{matrix} \} \cdot \\ {W}_{8}^{{n}_{3} ( {k}_{1} + 2 {k}_{2} )} {W}_{2}^{{n}_{3} {k}_{3}}\end{matrix} \} \cdot \\ {W}_{16}^{{n}_{4} ( {k}_{1} + 2 {k}_{2} + 4 {k}_{3} )} {W}_{32}^{{n}_{5} ( {k}_{1} + 2 {k}_{2} + 4 {k}_{3} )} {W}_{2}^{{n}_{4} {k}_{4}}\end{matrix} \} \cdot \\ {W}_{4}^{{n}_{5} {k}_{4}} {W}_{2}^{{n}_{5} {k}_{5}}\end{matrix} \} \cdot ] \cdot {W}_{N}^{{n}_{6} ( \begin{matrix}{k}_{1} + 2 {k}_{2} + 4 {k}_{3} + \\ 8 {k}_{4} + 16 {k}_{5}\end{matrix} )} {W}_{N / 32}^{{n}_{6} {k}_{6}} \\$$

In Equation 3, butterfly units having a form of radix-2 may be configured from n₁ to n₅.

The twiddle factors applied to the respective stages may be expressed by nₘ and kₘ.

When radix-2⁵ is derived according to Equation 3, it is possible to obtain an FFT flow as shown in FIG. 2.

Such a formula derivation process is used to form a variety of radix-2^{m} butterfly processors.

That is, it is possible to form radix-2^{m} butterfly processors each including the radix-2 butterfly unit 11, the buffer unit 12, the multiplexing unit 13, and the constant multiplier 14 as one stage.

FIG. 3 is a diagram explaining the configuration of a 32K-point FFT in accordance with the embodiment of the present invention.

Referring to FIG. 3, the 32K-point FFT in accordance with the embodiment of the present invention includes a radix-2⁵ butterfly processor 1, a memory unit 4, a twiddle ROM 2, and a multiplier 3.

The radix-2⁵ butterfly processor 1 is configured to perform a butterfly operation on input data through the radix-2 butterfly unit 11, as shown in FIGS. 1 and 2.

The memory unit 4 is configured to store data outputted from the radix-2⁵ butterfly processor 1, and the twiddle ROM 2 is configured to store a twiddle factor.

The multiplier 3 is configured to multiply the data outputted from the radix-2⁵ butterfly processor 1 by the twiddle factor outputted from the twiddle ROM 2.

The radix-2⁵ butterfly processor 1, the memory unit 4, the twiddle ROM 2, and the multiplier 3 are connected in a pipelined method to form the 32-K point FFT.

In accordance with the embodiment of the present invention, the number of complex multipliers occupying a large portion of the circuit size in the FFT may be minimized, and the number of multipliers may be optimized. Therefore, it is possible to reduce the circuit size and the power consumption.

Furthermore, when a modified radix-2⁵ butterfly processor and a general radix-2⁵ butterfly processor are used together, it is possible to support a variety of FFT lengths while sharing hardware.

Furthermore, the formula derivation process proposed in the embodiment of the present invention may be used to configure a variety of radix-2^{m} butterfly processors, and a hardware design method based on the radix-2^{m} butterfly processors may be derived.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A fast Fourier transformer (FFT) comprising:
a radix-2 butterfly unit configured to perform a butterfly operation on input data;
a buffer unit configured to buffer data outputted from the radix-2 butterfly unit and output the buffered data to the radix-2 butterfly unit;
a multiplexing unit configured to selectively output a twiddle factor; and
a constant multiplier configured to multiply the data outputted from the radix-2 butterfly unit by the twiddle factor outputted from the multiplexing unit.

2. The FFT of claim 1, further comprising a radix-2⁵ butterfly processor in which the radix-2 butterfly unit, the buffer unit, the multiplexing unit, and the constant multiplier are configured as one stage.

3. The FFT of claim 1, further comprising a radix-2^{m} butterfly processor in which the radix-2 butterfly unit, the buffer unit, the multiplexing unit, and the constant multiplier are configured as one stage.

4. The FFT of claim 3, wherein the twiddle factor is induced according to a division method based on a common factor algorithm in a discrete Fourier transform (DFT) formula.

5. The FFT of claim 3, wherein the buffer unit performs buffering as much as the butterfly operation time of the radix-2 butterfly unit.

6. An FFT comprising:
a radix-2⁵ butterfly processor configured to perform a butterfly operation on input data;
a memory unit configured to store data outputted from the radix-2⁵ butterfly processor and to output the buffered data to the radix-2⁵ butterfly processor;
a twiddle ROM configured to store a twiddle factor; and
a multiplier configured to multiply the data outputted from the radix-2⁵ butterfly processor by the twiddle factor outputted from the twiddle ROM.

7. The FFT of claim 6, wherein the radix-2⁵ butterfly processor, the memory unit, the twiddle ROM, and the multiplier are connected in a pipelined method.

8. The FFT of claim 6, wherein the twiddle factor is induced according to a division method based on a common factor algorithm in a DFT formula.
